(19) United States
(12) Patent Application Publication
(10) Pub. No.: US 2003/0182107 A1
(43) Pub. Date: Sep. 25, 2003

(54) Voice signal synthesizing method and device

(75) Inventor: I-Sheng Chan, Pan Chiao City (TW)

Correspondence Address: BACON & THOMAS, PLLC, 625 SLATERS LANE, FOURTH FLOOR, ALEXANDRIA, VA, 22314

(73) Assignee: Tenx Technology, Inc., Taipei Hsien (TW)

(21) Appl. No.: 10/101,591

(22) Filed: Mar. 21, 2002

(51) Int. Cl. G10L 19/00

(52) U.S. Cl. 704/212

(57) ABSTRACT

The present invention discloses a voice signal synthesizing method and device, wherein voice signals are sampled at a relatively lower sampling frequency. During the reproduction of the signals, interpolation is used to calculate values of voice signals between two sampled periods and the calculated values are filled between the two sampled periods, whereby lower distortion rate may be obtained in the reproduced voice. This invention provides a low distortion rate and low sampling frequency voice signal synthesizing method and device.

### FIELD OF INVENTION

The present invention relates to a voice signal synthesizing method and device, especially to a voice signal synthesizing method that uses interpolation method to improve quality of and to reduce noises in synthesized voices, and to the voice synthesizing circuit according to said method.

### BACKGROUND OF INVENTION

Most voice signal sampling method used a fixed sampling rate to abstract the sample a voice wave. A sampled analog voice wave is converted into digitized codes by an analog to digital converter (A/D converter). Such a voice signal coding system is called the pulse code modulation (PCM) method. As to the synthesis of voice signals, these voice signals are converted from PCM codes into analog signals by a digital to analog converter (D/A converter) at said fixed sampling rate. Because the signals are sampled at a fixed frequency, certain distortion will be found in the sampled codes, if compared with the original analog voice wave. If the sampling rate is lower, or if the resolution of the A/D converter is lower, the distortion of the sampled codes will become a severe problem.

FIG. 1 illustrates the relation between an original voice signal wave and the PCM sampled data of the voice wave. In this figure, the x coordinate represents the sampling time and the y coordinate represents the magnitude of the wave. Curve 1 represents the original voice wave and line 2 represents the voice wave after the voice wave 1 is PCM sampled and synthesized at a fixed frequency × Hz. As shown in this figure, when the analog voice wave 1 is sampled at the sampling rate of × Hz and synthesized with the same PCM method at the frequency of × Hz, the resulted voice wave 2 will have a certain differences in comparison with the original voice wave 1. The difference so generated will cause distortion in the output voice. In the known voice synthesizer, especially in a voice synthesizer IC, the sampling rate of the voice wave or the resolution of the A/D converter may be reduced, in order to save memory space or to extend the reduction time of the stored voice. Such reduction will bring more distortion to the synthesized voice signals.

In the prior art, higher sampling rate may be used to overcome the distortion. FIG. 2 illustrates a voice signal wave as the original voice wave 1 in FIG. 1 is sampled at the sampling rate of 4× Hz and synthesized at the rate of 4× Hz. In this figure, 3 represents the voice signal wave as sampled under the sampling rate of 4× Hz. As shown in this figure, after the voice wave is sampled under a 4 time sampling rate, the sampled voice signal wave is close to the original voice wave, thereby the distortion may be reduced. However, at such a sampling rate, the memory space to record the sampled voice data will be 4 times as that sampled under the rate of × Hz, resulted at an increased facility cost.

It is thus necessary to provide a novel voice signal synthesizing method and device that can sample voice signals with less distortion, while memory space used to record the sampled signals needs not be increased.

### OBJECTIVES OF INVENTION

The objective of this invention is to provide a novel voice signal synthesizing method and device that can sample voice signals with less distortion, while memory space used to record the sampled signals needs not he increased.

### SUMMARY OF INVENTION

According to the voice signal synthesizing method and device of this invention, the voice signals are sampled under a relatively lower sampling rate. During the reproduction of the sampled signals, interpolation is used to calculate values of voice signals between two sampling periods and the calculated values are filled in between the two sampling periods, whereby reproduced voices with reduced distortion rate may be obtained. This invention provides a voice signal synthesis method and device at a lower sampling rate with a reduced distortion rate.

The above and other objectives and advantages of this invention may be clearly understood from the detailed description by referring to the following figures.

### DESCRIPTION OF DRAWINGS

FIG. 1 illustrates an original voice wave and a synthesized voice wave, as the original voice wave is sampled under a lower sampling rate.

FIG. 2 illustrates another synthesized voice wave, resulting from sampling the original voice wave at a higher sampling rate.

FIG. 3 illustrates the original voice wave of FIG. 1 and a synthesized voice wave, as the original voice wave is sampled by the voice signal synthesizing method of this invention.

FIG. 4 shows the flow chart of the voice signal synthesizing method of this invention.

FIG. 5 illustrates a synthesized voice wave as sampled under a unit sampling rate and a reproduced voice wave as the synthesized voice wave is reproduced at a reproduction rate equal to 4 times the unit sampling rate.

Table 1 shows the values of the sampled voice signals and the reproduced voice signals of an embodiment of this invention, as a voice wave is sampled and reproduced under different sampling and reproduction rates.

### DETAILED DESCRIPTION OF INVENTION

The following is a detailed description of the voice signal synthesizing method and device of this invention.

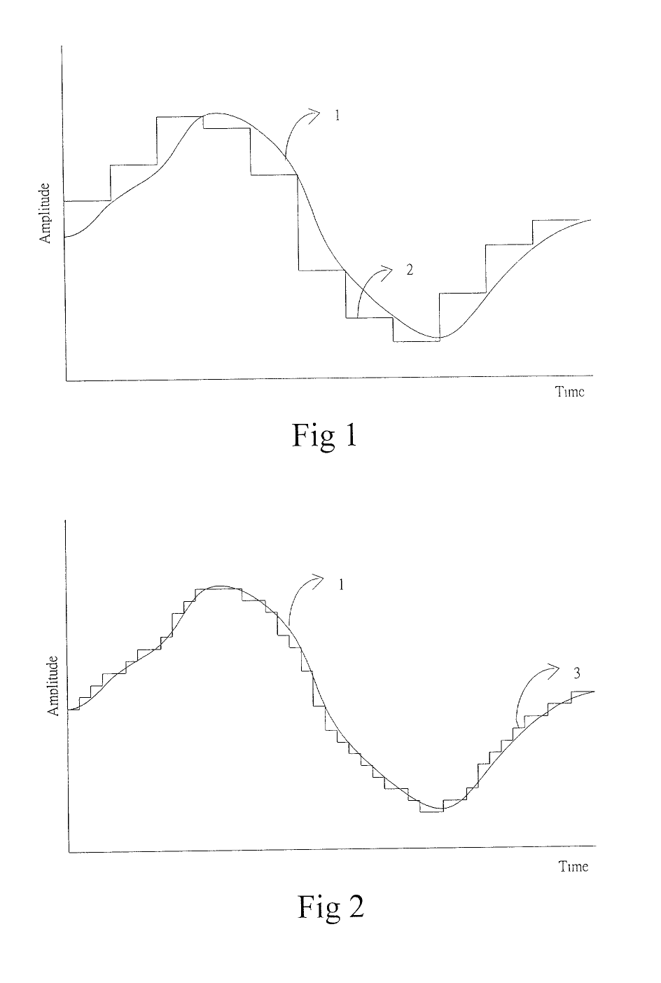

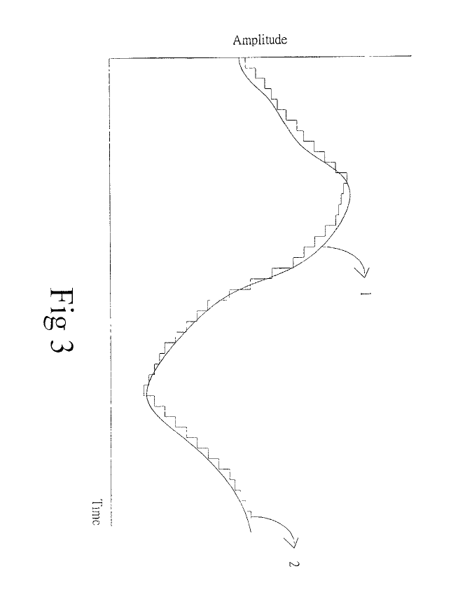

FIG. 3 illustrates the original voice wave of FIG. 1 and a synthesized voice wave, as the original voice wave is sampled by the voice signal synthesizing method of this invention. As shown in this figure, the voice wave 1 of FIG. 1 is sampled under the sampling rate of × Hz and reproduced at a 4-time reproduction rate (or play-back rate), 4× Hz. During the reproduction, three calculated values are interpolated between each pair of two sampled values. The reproduced voice wave 4 is shown in FIG. 3. The reproduce voice wave 4, though some differences are found between it and the original voice wave, is very close to the original voice wave 1. The distortion due to the low sampling rate (× Hz) may thus be reduced. To store the sampled voice signals, only the same memory space as needed by a voice wave as sampled at × Hz sampling rate will be sufficient.

In addition, in the voice signals as synthesized by this invention, the high frequency noises generated in the PCM voice synthesis process may be reduced and the distortion caused to the original voice due to low sampling rate may thus be effectively reduced.

### Embodiment

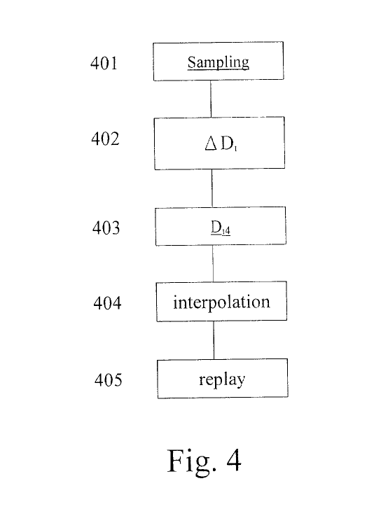

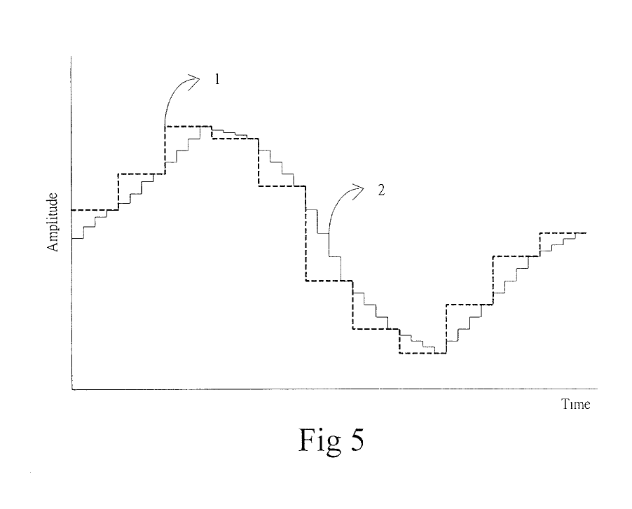

The description of an embodiment of the voice signal synthesizing method and device will be given below. FIG. 4 shows the flow chart of the voice signal synthesizing method of this invention. FIG. 5 illustrates a synthesized vie wave as sampled under a unit sampling rate and a reproduced voice wave as the synthesized voice wave is reproduced at a reproduction rate equal to 4 times the unit sampling rate.

According to the voice signal synthesizing method of this invention, first, at 401, a voice wave is sampled at the sampling rate of T, whereby in every 1/T second a PCM code of the voice signal wave is obtained. After the sampling, a voice signal data file D is obtained, D=D₁, D₂, D₃, . . . , Dₙ.

At 402, the difference between the values of each pair of adjacent PCM code is calculated and differences ΔDᵢ, ΔDᵢ,=Dᵢ₋₁, are obtained. At 403, every difference value is divided by 4 and the quarterly difference ΔDᵢ₄,ΔDᵢ₄=(1/4)ΔDᵢ, is obtained. At 404, three voice signals are filled between Dᵢ and Dᵢ₋₁. They are Dᵢ₋₁+(1/4)ΔD₁, Dᵢ₋₁+(2/4)ΔDᵢ and Dᵢ₋₁+(3/4)ΔDᵢ. A voice signal file D′ wherein the sampling (reproduction) rate is 4T, is obtained. At 405, the voice signals of the voice signal file D′ is reproduced at the rate of 4T, wherein the lasting time of a voice signal is 1/(4T).

### Effects of the Invention

FIG. 5 illustrates a synthesized voice wave as sampled under a unit sampling rate and a reproduced voice wave as the synthesized voice wave is reproduced at a reproduction rate equal to 4 times the unit sampling rate. Table I shows the values of the sampled voice signals and the reproduced voice signals of an embodiment of this invention, as a voice wave is sampled and reproduced under different sampling and reproduction rates. FIG. 5 and Table I both show that a synthesized voice wave that is close to the original voice wave may be obtained, when the calculated values of voice signals are interpolated between sampled signals and the resulted voice signals are reproduced at a higher reproduction rate.

According to this invention, the difference of values between two adjacent PCM coded signals is reduced, whereby the background high frequency noises generated during the synthesis may be effectively reduced. At the same time, because the obtained wave form is close to that of the original voice wave, the quality of the reproduced voice may be improved.

Although in the foregoing embodiment, the difference of values of two adjacent sampled voice signals are quadrate and three voice signal data are interpolated between them, it is possible to divide the difference with a smaller or greater divisor, and interpolate less or more calculated voice signal values. It is also possible to fill into two adjacent sampled voice signals at unequal intervals, to obtain similar or improved effects.

As the present invention has been shown and described with reference to preferred embodiments thereof, those skilled in the art will recognize that the above and other changes may be made therein without departing form the spirit and scope of the invention:

What is claimed is:

1. A method for the processing of voice signals, comprising the steps of:
obtaining a voice signal coded data file D from a voice source by coding a voice signal sample with the PCM coding at the sampling rate of T, wherein said voice signal coded data file D is consisted of PCM codes at a 1/T interval, D=D₁, D₂, D₃, . . . , Dₙ, n being an integral;
calculating the difference ΔDᵢ between the values of the PCM code of each pair of Dᵢ and Dᵢ₋₁, wherein 1<I<=n and ΔDᵢ=Dᵢ−Dᵢ₋₁,
filling between each pari of Dᵢ and Dᵢ₋₁ m−1 voice signal codes Dᵢ+(1/m)ΔDᵢ, Dᵢ+(2/m)ΔDᵢ, Dᵢ+(3/m)ΔDᵢ, . . . , Dᵢ+(m−1)/m)ΔDᵢ, wherein m is an integral; and
obtaining a coded voice signal data file comprising said PCM codes and said filled voice signal codes.

2. The method according to claim 1, wherein m is 4.

3. The method according to claim 1, wherein m is 2.

4. The method according to claim 1, wherein m is 8.

5. The method according to claim 1, 2, 3 or 4, further comprising a step of reproducing said coded voice signal date file at the reproduction rate of m*T.

6. A device to process voice signals, comprising:
a PCM sampling means to obtain a voice signal coded data file D from a voice source by coding a voice signal sample with the PCM coding at the sampling rate of T, wherein said voice signal coded data file D is consisted of PCM codes at a 1/T interval, D=D₁, D₂, D₃, . . . , Dₙ, n being an integral;
an interpolation means to calculate the difference ΔDᵢ betaken the values of the PCM code of each pair of Dᵢ and Dᵢ₋₁, wherein 1<I<=n and ΔDᵢ=Dᵢ−Dᵢ₋₁, and to fill between each pari of Dᵢ and Dᵢ₋₁ m−1 voice signal codes Dᵢ+(1/m)ΔDᵢ, Dᵢ+(2/m)ΔDᵢ, Dᵢ+(3/m)ΔDᵢ, . . . , Dᵢ+((m−1)/m)ΔDᵢ, wherein m is an integral; and
a memory means to store a coded voice signal data file comprising said PCM codes and said filled voice signal codes.

7. The device according to claim 6, wherein m is 4.

8. The device according to claim 6, wherein m is 2.

9. The device according to claim 6, wherein m is 8.

10. The device according to claim 6, 7, 8 or 9, further comprising a reproduction means to reproduce said coded voice signal date file at the reproduction rate of m*T.
